(19) United States
(12) Patent Application Publication
(10) Pub. No.: US 2016/0348406 A1
(43) Pub. Date: Dec. 1, 2016

(54) MOTOR VEHICLE DOOR LOCK

(71) Applicant: KIEKERT AKTIENGESELLSCHAFT, Heiligenhaus (DE)

(72) Inventors: Ulrich Weichsel, Duisburg (DE); Heiko Hemmer, Essen (DE); Omer Inan, Dorsten (DE)

(21) Appl. No.: 15/114,559

(22) PCT Filed: Jan. 28, 2014
(86) PCT No.: PCT/DE2014/000031

§ 371 Date: Aug. 18, 2016

(51) Int. Cl. E05B 77/16; E05B 81/16; E05B 81/66; E05B 81/06

(52) U.S. Cl. CPC E05B 77/16; E05B 81/06; E05B 81/16; E05B 81/66

(57) ABSTRACT

The invention relates to a motor vehicle door lock equipped with a locking mechanism essentially consisting of a rotary latch and a pawl, and with a locking element (2) for a locking lever (3). The locking element (2) prevents the locking lever (3) from moving into the locking position thereof when the rotary latch is open. In order to do so, the locking element (2) abuts the locking lever (3) to block same when the locking lever (3) is in the released position. According to the invention, the locking element (2) is designed as a locking nose (2) that is connected to a rotary latch-querying element (6).

The invention relates to a motor vehicle door latch with a locking mechanism essentially consisting of a catch and pawl, and with a blocking element for a locking lever, preventing the locking lever from assuming it locking position when the catch is open, with the blocking element abutting the locking lever when the locking lever is in the released position in order to block said lever.

In a motor vehicle door latch with the described design and as disclosed in DE 103 20 447 A1, the blocking element is a pushing lever, pivotally connected to a catch-querying lever. In this way, the blocking element and the catch-querying lever together form a crank mechanism. This is a simple way of preventing the locking lever from assuming its locking position. The aim is to ensure under all circumstances that the locking lever retains its released position as long as the blocking element engages in a respective recess of the locking lever in order to block said lever. Only once the latch lock, provided in this manner, leaves said recess, is the locking lever able to move, for instance, into the locked position.

The aim of the described measures as a whole is to ensure that the locking lever is, for instance, unable to assume its locked position when the door and thus the catch is open, as this could also cause the catch to be closed. As a result, the manually closed motor vehicle door could strike the obligatory locking bolt on the motor vehicle body as the catch is no longer open.

Irrespective of the above, the known catch-querying lever disclosed in DE 103 20 447 A1 allows to determine whether or not the catch is open.

Apart from the position of the locking lever, other functional states may depend on this. Depending on the position of the catch, the interior lighting is, for instance, switched on or off. The position of the catch also influences whether or not it should be able to trigger safety systems, such as an airbag. As long as the catch is open, i.e. is not in the main-ratchet position, the driver or passenger airbag may not be triggered. The interior lighting can be adapted to the position of the catch in such a way that it is, for instance, already switched on when the locking mechanism moves from a main-ratchet into a pre-ratchet position.

Apart from the already described generic state of the art as disclosed in DE 103 20 447 A1, EP 0 769 599 A1 discloses a design with a plunger that can be adjusted between a blocking and free position. In the blocking position, the plunger prevents an element of a locking lever chain from being adjusted. The free position of the plunger corresponds, on the other hand, to locking being possible. In this way, a simple and effective method is provided and the overall aim is to prevent locking of a motor vehicle door latch when, for instance, the key is left inside the motor vehicle body.

The prior art has generally proven to be successful but is, in parts, based on a plurality of components and thus an expansive design. Also, malfunctioning can thus not be ruled out with complete certainty. EP 0 769 599 A1 consequently regards the described plunger as an absolutely necessary component. In DE 103 20 447 A1, the blocking element and the catch-querying lever form a crank mechanism. This is the task of the invention.

The invention is based on the technical problem of further developing said motor vehicle door latch in such a way that reliable functioning is guaranteed despite of a simple design.

To solve this technical problem, a generic motor vehicle door latch of the invention is characterized by the blocking element being designed as a blocking nose connected to a catch-querying element.

According to the invention, the blocking element and the catch-querying element are thus combined or designed to form one (single) component. The invention actually uses a specially designed catch-querying element, also containing the blocking nose. The blocking nose functions as a blocking element for the locking lever and ensures that the locking lever does not assume its locking position or is blocked in its released position when the catch is open. The invention thus requires only few of components and is ultimately limited to the catch-querying element, also containing the blocking nose and which in this way can also take on the function of the blocking element in the described sense. This not only provides cost advantages but also increases functional reliability. As a crank mechanism as disclosed in DE 103 20 447 A1 is no longer required, failures, malfunctioning or indifferent functional states are basically not (no longer) possible.

In order to implement this in detail, the catch-querying element and the locking lever are arranged on more or less the same plane in an advantageous embodiment. As a result, the blocking nose of the catch-querying element can directly ensure, by carrying out a usually circular movement in the joint plane, that the locking lever remains in the released position as long as the catch is open. Only once the catch assumes its closed position and the catch-querying element is thus moved, does the blocking nose release the locking lever, which as a result moves or can move from the previously blocked released position into its locking position.

The catch-querying element is generally disc-shaped and is pivotally mounted on a respective axis of rotation in a latch housing. The blocking function of the catch-querying element with the connected blocking nose consequently corresponds to the catch-querying element carrying out a pivoting movement, taking into consideration a predefined pivoting angle. As a result, the blocking nose depicts a respective partial circle in order to be able to cooperate with the locking lever. Vice versa, the transition from the blocking position of the blocking nose of the catch-querying element or the transition from the previously blocked released position of the locking lever to the locking position, simply corresponds to the catch element and thus the blocking nose being pivoted around the axis of rotation.

Apart from the blocking nose, the catch-querying element advantageously also contains an extension for activating a sensor. This sensor can be a micro switch. The interaction of the extension on one hand and the sensor or micro switch on the other hand, serves to determine the position of the catch. For this purpose, the catch acts mechanically on the catch-querying element and ensures that the catch-querying element is correspondingly pivoted around its axis of rotation in the latch housing.

All in all, the design is such that the extension for activating the sensor, on one hand and the blocking nose for interacting with the locking lever, on the other hand, are essentially positioned diametrically opposite each other in relation to the axis of rotation of the catch-querying element. As a result, the individual functions can be easily separated from each other.

This also allows the best use of space, as the sensor or micro switch can be easily arranged next to or in the vicinity of the locking lever.

A compact design is also achieved due to the fact that the catch-querying element and the locking lever contain axes of rotation that are offset to each other. The locking lever is actually in most cases a central locking lever. In this context, the locking lever typically contains a V-shaped extension and a circular arc segment, allowing engagement of a drive motor. The V-shaped extension can contain cantilevers at the ends that mechanically interrupt a respective actuating lever chain (internal actuating lever chain and external actuating lever chain) in, for instance, the “locked” position of the locking lever and provide a mechanical connection of the respective actuating lever chain in the “released” position.

As the catch-querying element and the locking lever contain axes of rotation that are offset to each other, the catch-querying element and its blocking nose can interact with a V-leg of the V-shaped extension of the locking lever. This ensures the best possible use of the available installation space, in particular as the catch-querying element is arranged close to the axis of rotation of the locking lever and adjacent to a V-leg. This compact design is further aided by the fact that the blocking nose and a recess on the locking lever or on the V-leg of the locking lever are adapted to each other.

In this way, the blocking nose can engage in the respective recess on the locking lever when the catch-querying element pivots around its axis of rotation in order to block the locking lever. The locking lever is then blocked in its assumed “released” position and cannot move into the “locked” position. Only once the catch and thus the locking mechanism are closed or take up their main-ratchet position, has the catch-querying element moved or rotated around the axis to such an extent that the blocking nose moves out of the recess on the locking lever. The locking lever is released so that subsequently the locking lever moves and can also move from its previously blocked “released” position into the “locked” position.

As a result, a motor vehicle door latch is provided that provides a particularly compact and cost-effective design as no additional elements are used for providing the catch-querying element and the locking function for the locking lever. Instead, the already provided catch-querying element of the invention also functions as a blocking element. For this purpose, the catch-querying element contains the attached blocking nose. The blocking nose can be a partial arc segment radially arranged in relation to the axis of rotation of the catch-querying element.

The catch-querying element interacts directly or indirectly with the locking mechanism or with the catch. If the catch and thus the locking mechanism are in the “open” position, the locking lever is blocked in its “released” position. Only once the catch or the locking mechanism assumes their main-ratchet position and the catch-querying element follows the respective transition from the opened position to the main-ratchet position, is the locking lever released by the catch-querying element. The previously “released” position of the locking lever is eliminated, as the blocking nose emerges from the respective recess on the locking lever and releases the locking lever for a transition from the “released” into the “locked” position. This can be achieved in form of a central locking. This means that the locking lever is in most cases a central locking lever. This is, however, not mandatory.

Either way, the invention successfully prevents activation of safety systems, such as an airbag, as long as the catch or the locking mechanism is open. Only once the catch or the locking mechanism assumes its main-ratchet position, can the airbag in principle also be activated in this manner. Also, the aforementioned scenarios of controlling the interior lighting and preventing doors from being locked whilst the key is in the vehicle, can be achieved. This means that unintentional locking is impossible whilst the catch is open. These are the main advantages of the invention.

Below, the invention is explained in more detail with reference to a drawing, showing only one embodiment; in which:

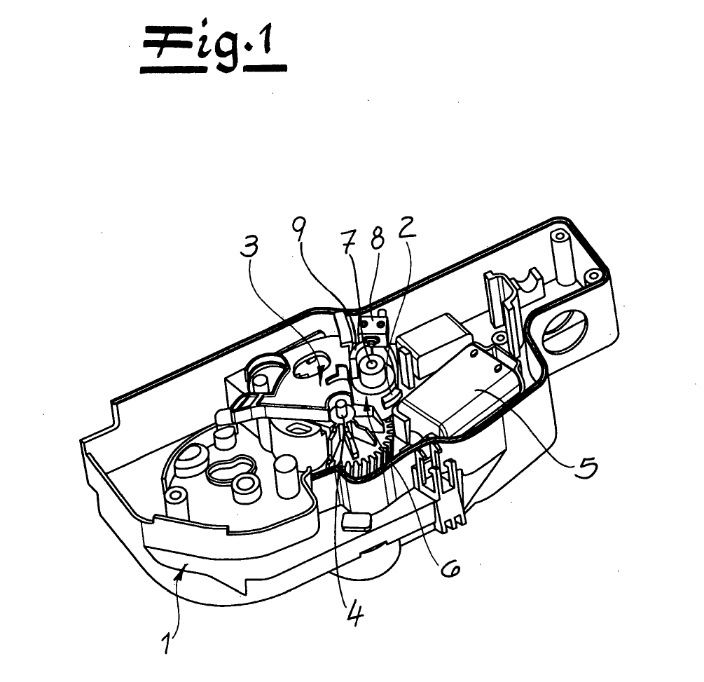

FIG. 1 shows a perspective overview of the motor vehicle door latch,

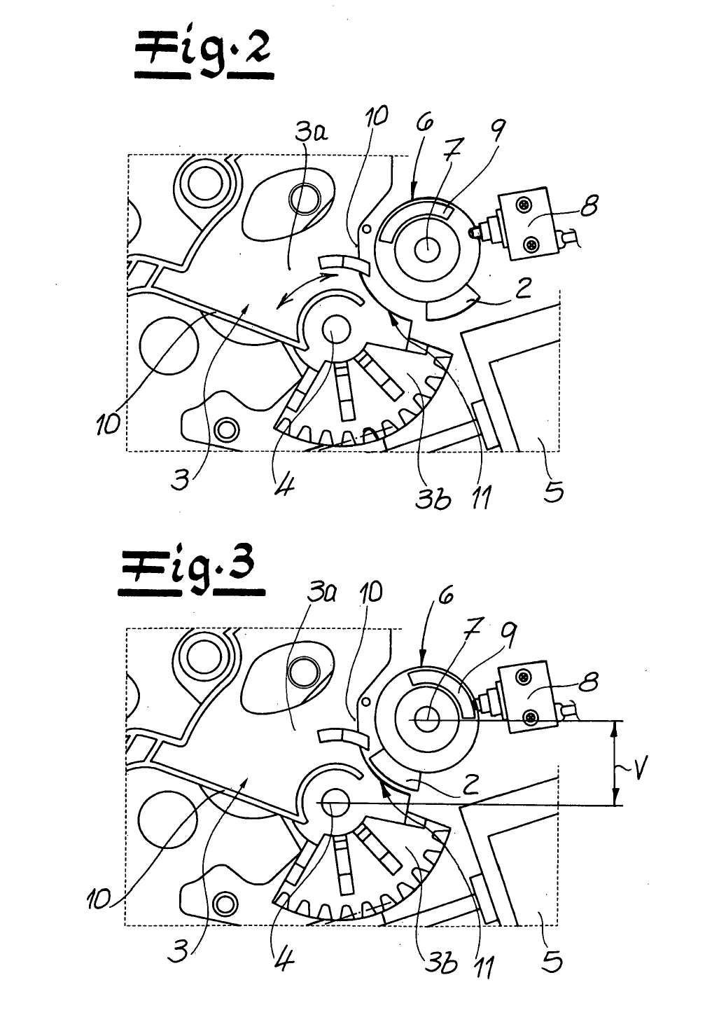

FIG. 2 shows a segment of FIG. 1 in the area of the locking lever with the locking lever in the “released” and the locking mechanism in the main-ratchet position

FIG. 3 shows the object of FIG. 2 with an open locking mechanism.

The figures show a motor vehicle latch containing, first of all, a housing 1. In addition, a provided, obligatory locking mechanism consisting essentially of a catch and pawl, can be mounted in a frame box that is independent of the housing 1 and is not explicitly shown in the drawings. The general design and topological arrangement of the latch housing 1, on one hand and the frame box -not shown—on the other hand, is disclosed in DE 20 2010 011 805 U1 of the applicant. A blocking element 2 for a locking lever 3 is assigned to the locking mechanism. In the embodiment, the locking lever 3 is a central locking lever 3.

The locking lever or central locking lever 3 is mounted in latch housing 1 and defines an axis of rotation 4. In particular from FIGS. 2 and 3 it is apparent that the locking lever 3, designed as a central locking lever, contains a V-shaped extension 3a and a circular arc segment 3b allowing engagement of a drive motor 5. The drive motor 5 actually contains a driving worm at its driven shaft, meshing with gears on the circumference of the circular arc segment 3b. As a result, the rotations of the driven shaft of the drive motor 5 are translated into rotary movements of the locking lever or central locking lever 3 around its axis of rotation 4 in clockwise or counterclockwise direction, as shown by the double arrow in FIG. 2.

The general design also includes a catch-querying element 6, which is also pivotally mounted in latch housing 1. The catch-querying element 6 is actually pivotally mounted around an axis of rotation 7 in the latch housing 1.

The catch-querying element 6 is acted upon by a locking mechanism or catch, not shown. This can be direct or indirect. In case of a direct actuation, the catch—not shown—ensures that the catch-querying element 6 is pivoted around its axis of rotation 7 compared to the latch housing 1, as for instance apparent in the transition from FIG. 2 to FIG. 3. According to FIG. 2, the functional position of the catch-querying element 6 actually corresponds to the main-ratchet position of the catch and thus also to the associated locking mechanism. According to FIG. 3, the functional position of the catch-querying element 6 corresponds instead to the catch and thus also the locking mechanism being open. The respective positions of the catch and thus of the locking mechanism are detected and recorded by a sensor 8.

In the embodiment, the sensor 8 is a micro switch 8. The micro switch 8 is acted upon by means of the extension 9 on the catch-querying element 6. In the “open” position of the locking mechanism, the extension 9 actually acts on the sensor or micro switch 8, which is triggered accordingly (see FIG. 3). The switching signal can be processed by a remote control unit—not shown. As a result, the interior lighting of a motor vehicle can, for instance, be switched on, when the catch-querying element 6 moves from the main-ratchet position, shown in FIG. 2, to the open position of FIG. 3. In addition, an airbag or also other safety elements may not be triggered in the “open” position of the catch, as already described above.

When the catch is open as shown in FIG. 3, the blocking element 2 for the locking lever 3 prevents that the locking lever 3 assumes or can assume its locking position. For this purpose, the blocking element 2 rests against the locking lever 3 when the locking lever 3 is in its released position, in order to lock it.

In the embodiment, the blocking element 2 is designed as the blocking nose 2 attached to the catch-querying element 6. This means that the catch-querying element 6, on one hand, and the blocking nose 2, on the other hand are designed as a (common and single) assembly 2, 6 and, according to the invention, the catch-querying element 6 also contains a blocking element 2 in form of a blocking nose 2. In the embodiment, the blocking nose 2 is a partial circle element, which is connected to the catch-querying element 6 at a radial distance from the axis of rotation 7.

It is apparent that the catch-querying element 6 and the locking lever 7 are arranged on more or less the same plane. When viewed from the top, the catch-querying element 6 also has a disk-shaped or cylindrical form. As already explained, the catch-querying element 6 is mounted in such a way that it is pivotable around its axis or axis of rotation 7. Said extension 9 and the blocking nose 2 are more or less diametrically opposed to each other in relation to the centre axis of rotation 7 as, in particular, apparent from FIG. 3. 8

The catch-querying element 6 or its axis of rotation 7 is offset in relation to the axis of rotation 4 of the locking lever 3 (see offset V in FIG. 3). The catch-querying element 6 is actually located in the immediate vicinity of a V-leg 10 of the V-shaped extension 3a of the locking lever 3. This produces a particularly compact design. The respective V-leg 10 contains a recess 11, whose size and design is adapted to the blocking nose 2. The blocking nose 2 can thus engage in the recess 11 in order to retain the locking lever 3 in its “released” position as shown in FIG. 3 as long as the locking mechanism or the catch assume the functional position “open”.

The arrangement functions as follows:

As soon as the locking mechanism or the catch moves from its main-ratchet position to the “open” or “opened” position, the catch-querying element 6 carries out an approximately 60° to 90° rotation around the respective axis of rotation 7 and in clockwise direction. This is apparent when comparing FIGS. 2 and 3. Prior to this and in order to open the locking mechanism, the locking lever 3 assumed its “released” position, as shown in FIGS. 2 and 3. In order to move the locking lever 3 from its “released” to its “locked” position, the drive motor 5 can be energized in such a way that the locking lever or central locking lever 3 moves in counterclockwise direction around its axis of rotation 4.

In the invention, such a movement of the locking lever 3 in counterclockwise direction is prevented in case that the locking mechanism is in the “open” position (see FIG. 3). This functional position “open” of the locking mechanism corresponds to the blocking nose 2 attached to the catch-querying element 6, engaging in the recess 11 on the V-leg 10 of the locking lever 3. As a result of this interaction, the locking lever 3 cannot be moved into its “locked” position by a counterclockwise pivoting movement around the axis of rotation 4 (see FIG. 2).

This means that when the catch is open, the locking lever 3 is locked in its released position by means of the blocking element or blocking nose 2. For this purpose, the blocking nose rests against the locking lever 3 when the locking lever 3 is in its released position, in order to block it

1. A motor vehicle door latch equipped with a locking mechanism essentially consisting of a catch and pawl and with a blocking element for a locking lever, preventing the locking lever from assuming its locking position when the catch is open and in which the blocking element abuts the locking lever to block the same when the locking lever is in a released position, wherein the blocking element is designed as a blocking nose attached to a catch-querying element.

2. The motor vehicle door latch according to claim 1, wherein the catch-querying element and the locking lever are arranged on more or less the same plane.

3. The motor vehicle door latch according to claim 1, wherein the catch-querying element is disc-shaped and is pivotally mounted around a respective axis of rotation inside a latch housing.

4. The motor vehicle door latch according to claim 1, wherein the catch-querying element contains an extension for actuating a sensor, such as a micro switch.

5. The motor vehicle door latch according to claim 4, wherein the extension and the blocking nose are essentially diametrically opposed to each other in relation to the centre axis of rotation.

6. The motor vehicle door latch according to claim 1, wherein the catch-querying element and the locking lever contain axes of rotation that are offset to each other.

7. The motor vehicle door latch according to claim 1, wherein the locking lever is designed as a central locking lever.

8. The motor vehicle door latch according to claim 1, wherein the locking lever contains a V-shaped extension and a circular arc segment allowing engagement by a drive motor.

9. The motor vehicle door latch according to claim 1, wherein the blocking nose of the catch-querying element interacts with a V-leg of the V-shaped extension of the locking lever.

10. The motor vehicle door latch according to claim 9, wherein the blocking nose and a recess on the V-leg are adapted to each other.
